(19) United States
(12) Patent Application Publication
(10) Pub. No.: US 2005/0132360 A1
(43) Pub. Date: Jun. 16, 2005

(54) Network boot sequence in the absence of a DHCP server

(76) Inventors: Simon C. Chu, Chapel Hill, NC (US); Richard A. Dayan, Raleigh, NC (US); James L. Matlock, Cary, NC (US); David B. Rhoades, Raleigh, NC (US)

Correspondence Address: LALLY & LALLY, L.L.P., P. O. BOX 684749, AUSTIN, TX, 78768-4749, US

(21) Appl. No.: 10/733,656

(22) Filed: Dec. 11, 2003

(51) Int. Cl. G06F 9/445

(52) U.S. Cl. 717/177

(57) ABSTRACT

A data processing system suitable for use as a client device in a network includes a service processor communicatively coupled to a general purpose processor of the system. The system is enabled to respond to a boot event by requesting boot information from a network device. If the boot information request expires unsuccessfully, the boot information is requested from the service processor. If the attempt to retrieve the boot information from the service processor is successful, the retrieved boot information is used to establish a network connection to a file transfer server. The file transfer server connection is then used to download an operating system image from the file transfer server to boot the operating system image and install an operating system on the client device. In one embodiment, the client device is a PXE client on a network lacking a DHCP server.

### BACKGROUND

1. Field of the Present Invention

The present invention is in the field of data processing networks and more particularly, data processing networks in which client devices use the network to download an operating system.

2. History of Related Art

In the field of data processing networks, it is well known to implement client devices that may or may not have fixed disk drives or other facilities that would support a conventional system boot in which operating system code is stored locally and retrieved into memory as part of the boot process. Increasingly, client systems in a networked environment use the network to retrieve or download all or some of an operating system from a server device on the network. Networked installed operating systems not only decrease the requirements for persistent storage that is local to each client system, but they also facilitate control over the operating system software that is deployed throughout an enterprise.

To support networked installation of operating system software, a protocol or standard referred to as the “pre-execution environment” (PXE) has been developed. PXE defines the mechanism by which compliant systems may retrieve an operating system from a remote server over a network such as a corporate LAN. Basically, the BIOS of a PXE compliant client responds to a system boot by requesting an IP address and some additional information including the location (server and filename) of the operating system to be downloaded. Once the client has an IP address, requests for operating system files can be made using conventional file transfer protocols such as FTP or TFTP.

Referring to FIG. 1, a PXE-compliant client 102 responds to a system boot 120 by requesting (121) a DHCP “discover” asking for an IP address. Throughout this disclosure, the terms “client” and “client system” refer to any device that implements PXE and boots its operating system via a network connection. In this context, a client system may be any type of data processing system including a notebook or desktop PC or a server class system. If there are any DHCP servers 104 on the network that receive the DHCP discover, each one may respond by issuing a DHCP offer (122) for an IP address. (In the depicted embodiment, only a single DHCP server 104 is shown). DHCP server 104 responds to DHCP discover 121 by providing (122) PXE client 102 with an IP address and other necessary configuration information including the name of a TFTP server and a filename for the operating system kernel. PXE client 102 responds to the successful retrieval of this information by sending a TFTP request (124) for the operating system kernel to the identified TFTP server 106. TFTP server responds to the request 124 by returning (126) to PXE client 102 an operating system image, which the client can then use to boot an operating system.

The use of DHCP as a means of assigning IP addresses to clients in a network is perceived by some as introducing a potential security comprise into the network. Some network administrators worry that a rogue server might obtain an IP address using DHCP and, from there, begin to compromise the network. Administrators of some networks have addressed this concern by prohibiting the presence of any DHCP servers on critical portions of the network. In environments where there are no DHCP servers, it is desirable, nevertheless, to use PXE as a mechanism for booting systems remotely. It would be desirable, therefore to implement a method and system for enabling a PXE client to function in an environment that lacks a DHCP server.

### SUMMARY OF THE INVENTION

The objective defined above is achieved by a data processing system or service suitable for use as or with a client device in a network according to the present invention. The system includes a service processor communicatively coupled to a general purpose processor of the system. The system is enabled to respond to a boot event by requesting boot information from a network device. If the boot information request expires unsuccessfully, the boot information is requested from the service processor. If the attempt to retrieve the boot information from the service processor is successful, the retrieved boot information is used to establish a network connection to a file transfer server. The file transfer server connection is then used to download an operating system image from the file transfer server to boot the operating system image and install an operating system on the client device. In one embodiment, the client device is a PXE client on a network lacking a DHCP server. In this embodiment, the PXE client performs PXE boot sequence by first attempting to obtain an IP address from a DHCP server in the conventional manner and, following the unsuccessful termination of the DHCP attempt, the PXE client obtain boot information including an IP address and the IP address for a TFTP server from which the PXE client can download an operating system image.

### BRIEF DESCRIPTION OF THE DRAWINGS

Other objects and advantages of the invention will become apparent upon reading the following detailed description and upon reference to the accompanying drawings in which:

FIG. 1 is a block diagram illustrating selected elements of a PXE boot sequence according to the prior art;

FIG. 2 is a block diagram illustrating a comparable boot sequence in a network lacking a DHCP server;

FIG. 3 is a block diagram illustrating a successful PXE boot sequence in the absence of a DHCP server according to one embodiment of the invention;

FIG. 4 is a conceptual representation of a table containing boot information suitable for use by the client of FIG. 3; and

FIG. 5 is a flow diagram of a service for enabling a customer to implement a PXE client without regard to the presence of a DHCP server on the network.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Broadly speaking the present invention contemplates a system and service for implementing PXE on one or more client systems in a DHCP-free network environment. The client system BIOS or NIC firmware is configured to issue a DHCP-compliant request for an IP address following a boot event. When the client's request times out due to the lack of a DHCP server on the network, the client system is configured to consult an out of band storage device for the information it needs to locate and retrieve an operating system image. In the preferred embodiment, the client has a service processor and memory associated therewith. A deployment server of the system pre-configures the service processor storage with information needed by the client (i.e., the information that the client would have received from a DHCP server). In this way, the client can retrieve an image without altering the PXE implementation and without introducing a DHCP server into the network.

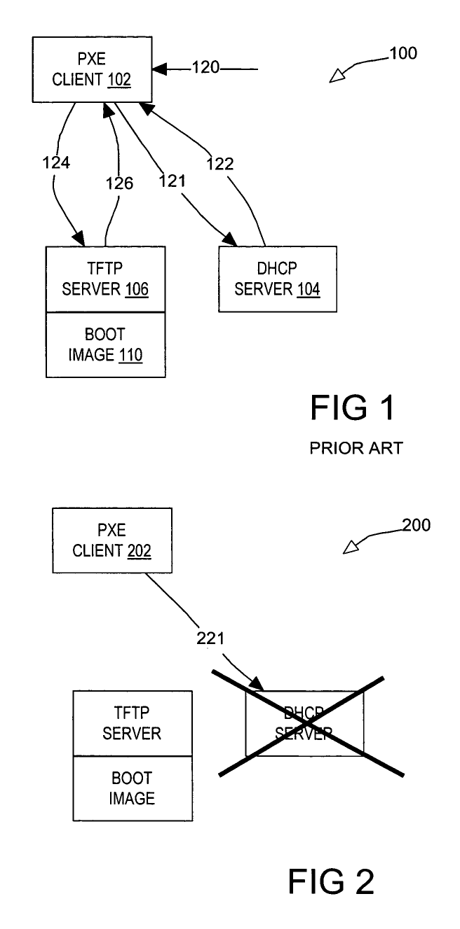

Turning now to the drawings, FIG. 2 is a conceptual illustration of a data processing network 200 presented to emphasize the problem addressed by the present invention. Many customers and end users want or need to use an industry standard network boot protocol such as PXE. Simultaneously, however, many of these same users are apprehensive about placing a DHCP server in their mission critical data centers and other networks for fear that, if a rouge user is able to hack its way into the network and obtain an IP address from the DHCP server, that user can then cause significant and potentially irreparable damage. Thus, some customers require a PXE solution but prohibit the DHCP server upon which PXE relies. This situation is illustrated in FIG. 2 by the system 200 that includes substantially all of the elements of system 100 as depicted in FIG. 1 with the exception of the DHCP server 104 of FIG. 1, which has been removed from system 200 by customer mandate. In this environment, the PXE boot sequence breaks down almost immediately after the PXE client system 202 issues a DHCP discover 221. The lack of a DHCP server causes the discover 221 to remain unfilled (i.e., timeout) at which point PXE client 202 is unable to continue because it has no IP address and it cannot find the operating system boot image on the network.

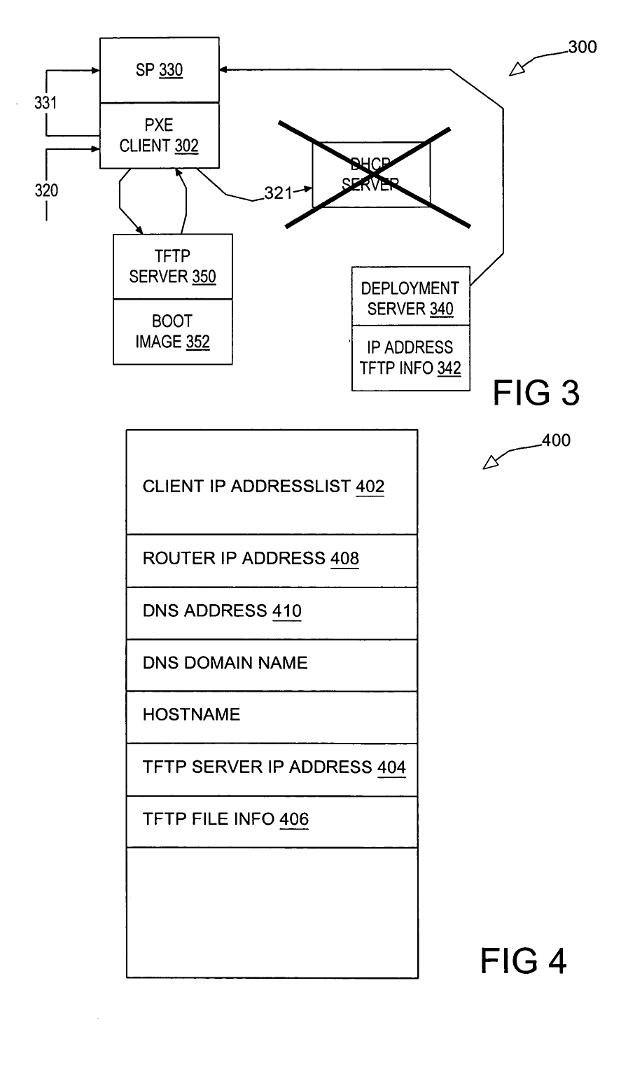

Referring now to FIG. 3, a block diagram illustrates selected elements of a data processing network 300 and a PXE client 302 according to one embodiment of the present invention. Generally speaking, PXE client 302 is a data processing system, such as a server-class computer system, that includes one or more general purpose microprocessors, a system memory accessible to the processors, and a sequence of processor executable instructions (computer software), stored in a persistent storage device such as a ROM, flash memory device, or the like, for performing a PXE boot sequence and for completing the sequence in the absence of a DHCP server on the network.

In the depicted embodiment, PXE compliant client device 302 is shown as responding to a system boot 320 by first attempting to locate a DHCP server via a DHCP discover 321. When the DHCP process times out for lack of a response, the present invention attempts to retrieve the information it needs to boot itself from an alternative source. More specifically, PXE client 302 is preferably configured with a service processor (SP) 330 from which PXE client 302 can obtain information needed to complete the PXE boot process.

Service processor 330 is a secondary processor of PXE client 302 and is responsible for supervisory system tasks not appropriate for the client's primary general purpose microprocessors. As such, SP 330 preferably includes its own persistent and dynamic memory. Moreover, to insure reliable supervision of client 302, SP 330 is preferably powered by a source of AC power that is distinct from the power source provided to client 302. SP 330 may be integrated onto a system board with the primary, general purpose processors of client 302.

In another embodiment, SP 330 is provided via an expansion or adapter card that is inserted into an expansion slot of client 302. This embodiment of SP 330 may be implemented, for example, with a Remote Supervisor Adapter (RSA) from IBM Corporation. The RSA provides remote system management for server-class data processing systems. RSA facilitates systems management by providing around-the-clock remote access to the supported server system. RSA enables features including graphical console redirection, keyboard and mouse control, remote management independent of the server status (power), full remote control of hardware and operating systems, and remote update of server system firmware and Web-based management from standard Web browsers. The RSA includes a variety of I/O ports, including a serial port, an Ethernet port, and a dedicated system's management interconnection port enabling “sideband” communication with the PXE client 302.

Regardless of its specific implementation, SP 330 according to the present invention is employed to provide network information to PXE client 302 that would otherwise be provided by a DHCP server during a conventional PXE boot sequence. As such, SP 330 is configured to store information needed by PXE client 302 to boot an operating system image via the network. In one embodiment, SP 330 is provided with information that enables PXE client 302 to obtain an IP address on the network and to transfer the necessary operating system files from a file server. In an embodiment that is desirable for its comparative simplicity, the PXE client 302 uses a Trivial File Transfer Protocol (TFTP) to transfer the operating system files that it needs via the network.

The depicted embodiment of network 300 includes a deployment server 340. DS 340 facilitates remote network deployment tasks including initial operating system installation, BIOS updates, and disposal of retired systems. DS 340 preferably includes the ability to capture images from and deploy images to systems, generate and execute unattended install scripts, support PXE-compliant hardware regardless of vendor, securely dispose of data on systems being retired, and integrate with systems management software products such as the IBM Director product from IBM Corporation. DS 340 is exemplified by the Remote Deployment Manager (RDM) product available from IBM Corporation, although the choice of deployment manager is an implementation detail.

In addition to its network deployment tasks, deployment server 340 is configured to provide the information (referred to herein as “boot information”) PXE client 302 needs to complete a PXE boot sequence in the absence of a DHCP server. In one embodiment, DS 340 “pre-configures” PXE client 302 with boot information such that the information is immediately available to PXE client 302 following a power on, reset, or other boot event. In another embodiment, the boot information is stored on DS 340 and is downloaded to SP 330 on an as-needed basis. It will be appreciated that, although FIG. 3 depicts a single PXE client 302 in network 300 for the sake of simplicity, a typical implementation will likely include two or more such clients.

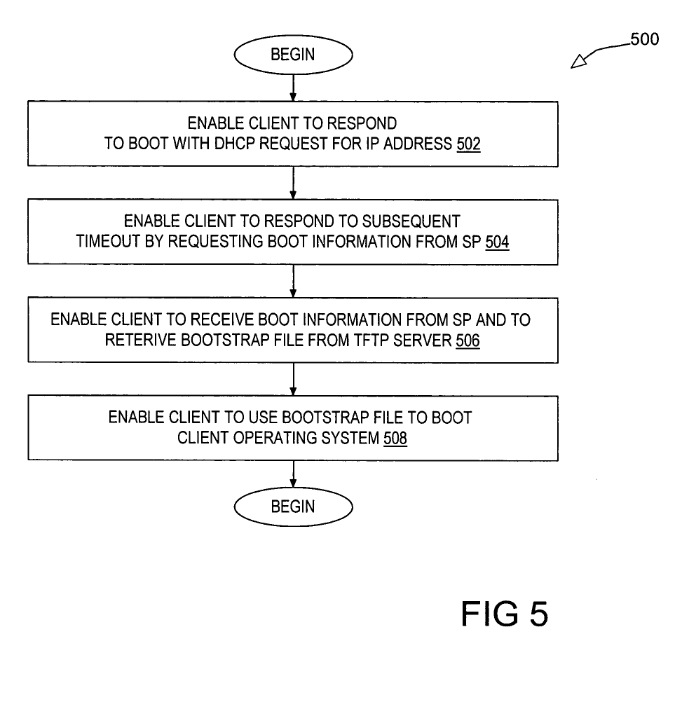

Referring to FIG. 4, a conceptual representation of a data table 400 within deployment server 340 is depicted to illustrate one example of the boot information stored on DS 340. In the depicted embodiment, table 400 includes a list (402) of valid IP addresses that DS 340 has at its disposal for assignment to the various PXE clients, the IP address 404 of at least one TFTP server on the network, and TFTP filename information 406 that contains the path and name(s) of the file(s) PXE client 302 needs to bootstrap an operating system. Table 400 may include additional information such as the IP addresses of any routers in the network, and domain name server (DNS) address information 410.

In one embodiment, DS 340 is configured to communicate with SP 330 of PXE client 302 for the purposes of providing boot information for PXE client 302 to SP 330. This communication is likely achieved using an Internet protocol stack such as TCP/IP using a unique IP address for SP 330. In other embodiments, a dedicated or sideband connection (such as a serial link) may be provided between DS 340 and SP 330. Regardless of the communication specifics, DS 330 is enabled to act as a pseudo-DHCP server by issuing an IP address for PXE client 302. Whereas a DHCP sever would issue an IP address to PXE client 302 using a direct connection, the present invention uses DS 340 to provide the IP address, not to PXE client 302 itself, but instead to a device to which PXE client 302 is able to communicate. Moreover, whereas a DHCP server complies with a publicly defined protocol that may make the server susceptible to compromise by an unintended agent, the communication between deployment server 340 and PXE client 302 can be customized and proprietary.

PXE client 302 according to the present invention is configured to retrieve boot information from its SP 330 following a timeout of a DHCP request. Thus, if a DHCP discover issued by PXE client 302 fails to generate a response from a DHCP server, PXE client 302 requests the boot information from its SP 330. In one embodiment desirable for enhanced security, the communication (331) between PXE client 302 and its SP 330 is out of band with respect to a network interface (not shown) of PXE client 302. PXE client 302 and SP 330 may communicate, for example, over a dedicated serial link. In another embodiment, the PXE client 302 is configured not to issue the DHCP Discover (321) at all following reset. Instead, this embodiment of PXE client 302 responds to a boot event by retrieving information from SP 330. This embodiment might thwart a rogue server that would otherwise attempt to provide bogus DHCP and PXE information in response to the DHCP Discover. Because the PXE specification prioritizes a server that responds with both DHCP info and PXE information over a server that is just a PXE server, a rogue server might gain unauthorized access to client system 302 by posing as a DHCP server.

Following its retrieval of the required boot information, PXE client 302 is configured to resume its PXE boot as if its DHCP discover had been properly responded to. In the depicted embodiment, this includes requesting a transfer of a boot image 352 from a TFTP compliant sever 350. PXE client 302 generates a TFTP request for boot image 352 using the IP address 402 (FIG. 4) of client 302, the IP address 404 of TFTP server 350, and the TFTP file information 406 (all of which were obtained from SP 330). TFTP information 406 includes the name and path of boot image 352.

Thus, FIG. 3 and FIG. 4 depict an embodiment of the present invention in which a PXE client 302 responds to a DHCP timeout event by retrieving boot information from its service processor. Implementation of PXE client 302 as described herein requires only a modest amount of code to handle the DHCP timeout by retrieving boot information from SP 330. Once PXE client 302 retrieves the boot information, it can resume the remainder of a conventional PXE boot sequence. Thus, in this embodiment, PXE client 302 is a fully compliant PXE client and the invention does not contemplate alteration of the PXE protocol itself. In an embodiment that suppresses the DHCP discover message following reset or power on, additional code modifications may be required.

One embodiment of the present invention includes providing a service to enable a customer or end-user to achieve the equivalent of a PXE boot sequence in a network that lacks a compliant DHCP server. Referring to FIG. 5, an embodiment of a service 500 according to such an embodiment of the invention is shown. In the depicted embodiment, a client's PXE client is configured or enabled (block 502) to issued a DHCP-compliant request (or, more precisely, a DHCP broadcast) in response to a system boot event (e.g., a reset or power on). A provider of server 500 also enables (block 504) the customer's PXE client to respond to a DHCP timeout by seeking boot information from its service processor. The service processor may be pre-configured with the boot information by a deployment server or it may obtain the boot information from a deployment server at run time. In the pre-configured implementation, the service processor may select an IP address from a set of multiple available IP addresses and communicate the selected IP address, not only to the client system, but also back to the deployment server so that the deployment server can update lists of available IP addresses located in the service processors of any other clients on the network that do not yet have an IP address. The customer's PXE client is further enabled (block 506) to respond to the receipt of the boot information from the service processor by using the boot information to establish a connection with a file transfer server that contains a copy of an operating system image. Finally, the service provider enables (block 508) the PXE client to use the boot information and the file transfer connection to retrieve and boot an operating system image from the file transfer server.

In one embodiment, the services illustrated in FIG. 5 are made more general by enabling the PXE client to make a decision following the issuance of a DHCP discover. If a DHCP server is present and responds to the discover, the PXE client finishes the PXE boot sequence in the conventional manner. If, however, the DHCP discover produces no response from a DHCP server, the described alternative method of completing the boot sequence is undertaken.

It will be apparent to those skilled in the art having the benefit of this disclosure that the present invention contemplates a mechanism for enabling PXE clients in the absence of an available DHCP server. It is understood that the form of the invention shown and described in the detailed description and the drawings are to be taken merely as presently preferred examples. It is intended that the following claims be interpreted broadly to embrace all the variations of the preferred embodiments disclosed.

1. A data processing system suitable for use as a client device in a network, the system including a general purpose processor and memory accessible to the general purpose processor, comprising:
a service processor communicatively coupled to the general purpose processor;
computer code means for responding to a boot event by requesting boot information from a network device;
computer code means for determining that the boot information request expired unsuccessfully and, responsive thereto, for requesting the boot information from the service processor;
computer code means for responding to the successful retrieval of the boot information from the service processor by using the retrieved boot information to establish a network connection to a file transfer server; and
computer code means for using the file transfer server connection to download an operating system image from the file transfer server and code means for booting the operating system image to install an operating system.

2. The system of claim 1, wherein the file transfer server is a TFTP compliant server and wherein the service processor includes storage containing boot information including an IP address for the TFTP server and the path and name of an operating system image on the TFTP server.

3. The system of claim 1, wherein the code means for responding to the boot event includes code means for responding to the boot event by performing a DHCP broadcast to determine the presence on the network of a DHCP compliant server.

4. The system of claim 3, wherein the code means for determining that the boot information request terminated unsuccessfully includes code means for receiving a network timeout message corresponding to the DHCP broadcast.

5. The system of claim 1, wherein the code means for responding to the boot event comprises PXE compliant code means.

6. The system of claim 1, further comprising a deployment server having access to a table containing the boot information and further configured to provide the boot information to the service processor.

7. The system of claim 6, wherein the deployment server is configured to provide the boot information to the service processor in response to a timeout event following a DHCP broadcast by the system.

8. The system of claim 7, wherein the boot information table includes a list of IP address assignable by the deployment server to the client.

9. A service to permit a customer to install an operating system on a remote client via a network, comprising:
enabling a client device to respond to a boot event by making a first attempt to obtain an IP address via the network;
enabling the client device to respond to the unsuccessful termination of the first attempt by making a second attempt to obtain the IP address from a service processor of the client system;
enabling the client to respond to the successful completion of the second attempt, by using the obtained IP address to establish a connection with a file transfer server;
enabling the client to use the file transfer server connection to retrieve an operating system image from the file transfer server and boot the operating system image.

10. The service of claim 9, wherein making the first attempt to obtain an IP address comprises issuing a DHCP discover.

11. The service of claim 9, wherein enabling the client to establish a connection with the file transfer server includes providing the service processor with an IP address of file transfer server.

12. The service of claim 11, wherein enabling the client to use the file transfer server to obtain an operating system image includes providing the service processor with a path and name of files needed to boot the operating system.

13. The service of claim 9, further comprising, enabling a deployment server on the network to provide PXE information, including IP address information, to the service processor.

14. The service of claim 13, wherein the deployment server pre-configures the service processor with the PXE information wherein the information is installed on the service processor when the client is booted.

15. The service of claim 13, wherein the deployment server is configured to provide the PXE information to the service processor at run time.

16. A computer program product comprising a set of computer executable instructions for installing an operating system to a remote system on a network, the instructions being stored on a computer readable medium, comprising:
computer code means for responding to a client system being booted by obtaining an IP address from a service processor of the client system;
computer code means for obtaining an IP address for a file server and a file path and name for an operating system image on the file server from the service processor;
computer code means for using the obtained IP addresses and file path and name to transfer the operating system image from the file server to the client system.

17. The computer program product of claim 16, wherein the code means for obtaining the IP address from the service processor are invoked prior to the client system issuing a DHCP discover to obtain its IP address.

18. The computer program product of claim 16, wherein the code means for obtaining the IP address from the service processor are invoked responsive to timeout following the client system issuing a DHCP discover.

19. The computer program product of claim 16, further comprising code means of the service processor for obtaining the IP address and file path and name from a deployment server.

20. The computer program product of claim 19, wherein the code means of the service processor are responsive to a request from the client system following a boot event such that the IP address and file path and name are obtained from the deployment server at run time.
